(19) United States
(12) Patent Application Publication
(10) Pub. No.: US 2013/0317940 A1
(43) Pub. Date: Nov. 28, 2013

(54) HANDLING PURCHASE ORDERS

(71) Applicant: PETER JOSEF FITZ, Waldsee (DE)

(72) Inventor: PETER JOSEF FITZ, Waldsee (DE)

(21) Appl. No.: 13/481,090

(22) Filed: May 25, 2012

(51) Int. Cl. G06Q 30/06

(52) U.S. Cl. 705/26.8

(57) ABSTRACT

Systems, methods and techniques relating to handling purchase orders are described. A described technique includes identifying a first purchase order, wherein the first purchase order associated with one or more attributes, identifying one or more stop rules and one or more restart rules associated with at least one of the identified one or more attributes, postponing the first purchase order to be submitted to at least one supplier based on at least one of the one or more stop rules, identifying a second purchase order, wherein the second purchase order is associated with at least one of the one or more attributes while the first purchase order is postponed, combining the first purchase order and the second purchase order to a combined purchase order, and submitting the combined purchase order to at least one supplier when at least one of the one or more restarting rules is satisfied.

### TECHNICAL FIELD

The present disclosure relates to handling purchase orders.

### BACKGROUND

In business transactions, products may either be purchased in small amounts, or several products that sharing certain attributes may be aggregated to a larger amount and purchased together. For example, products for direct usage or consumption such as laptops and mobile phones are often ordered in small amount. When an employee submits a purchase order of a mobile phone (e.g., by adding the products to a shopping cart or submitting the requests through an internal purchasing system), a business transaction system can find a valid source of supply for the products included in the purchase order and immediately create a purchase order. If no valid source of supply is found, the business transaction system can place the purchase order in an open task list. In many cases, when multiple purchase orders are combined to form a substantial purchase order including a large amount of products, a better per product price or a lower cost of shipping and insurance of the products can be obtained.

### SUMMARY

This disclosure provides various implementations of systems, computer program products, and methods for handling purchase orders. A procurement system identifies a first purchase order, wherein at least a portion of the first purchase order is associated with one or more attributes that allow purchase orders to be combined and submitted at the same time. The procurement system identifies one or more stop rules and one or more restart rules associated with at least one of the identified one or more attributes. The at least the portion of the first purchase order is postponed to be submitted to at least one supplier based on at least one of the one or more stop rules. The procurement system then identifies a second purchase order, wherein at least a portion of the second purchase order is associated with at least one of the one or more attributes while the first purchase order is postponed. The at least the portion of first purchase order and the at least the portion of the second purchase order are combined to a combined purchase order. The combined purchase order is then submitted by the procurement system to at least one supplier when at least one of the one or more restarting rules is satisfied.

While generally described as a computer program that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic representation of an example system environment suitable for one or more implementations according to the present disclosure.

FIG. 2 is a schematic showing an example system for handling purchase orders.

FIG. 3 is a schematic showing an example process of handling purchase orders.

FIG. 4 is a schematic showing another example process of handling purchase orders.

FIG. 5 is a schematic showing yet another example process of handling purchase orders.

FIG. 6 is a flowchart showing an example process of handling purchase orders.

Like reference symbols in the various drawings indicate like elements.

### DETAILED DESCRIPTION

This disclosure provides details and examples of handling purchase orders. In a general aspect, a product purchase order with certain attributes may not need to be fulfilled by a supplier right away, based on the type of items being purchased, an indication from the requesting party, or other suitable determinations. In such cases, a procurement system may postpone the purchase order for a predetermined period of time and/or while waiting for one or more criteria to be met, and, during that time, the procurement system can combine the postponed purchase order with one or more purchase orders received afterwards the initial postponement to form a combined purchase order, in order to save procurement costs. For example, a purchase order of a smart phone may include example attributes including “cell phones,” “electronics,” and “wireless service provider.” These attributes may be associated with one or more order processing rules, with some examples including: “five cell phone orders qualify for a 15% discount;” “orders of electronics products over $200 enjoys free shipping;” or “product orders that requires associated wireless services needs to be fulfilled in a week.” Based on the identified attributes that associated with the order processing rules, a first purchase order of, for example, a smart phone may be postponed and combined with additional purchase orders of smart phones or other electronics in order to meet at least one of the order processing rules. In some instances, when at least one order processing rule is met, the procurement system submits the combined purchase order to at least one supplier to save on total procurement cost. In some other instances, the procurement system may wait for more than one order processing rule to be met in order to further save on the total procurement cost. Different types of stop and restart rules may be associated with different types of products, different requesters or roles of requesters, as well as other purchase order attributes. In some instances, multiple rules may be analyzed for a particular postponed purchase order, such that satisfaction of one or more of the rules can cause the purchase order to be closed and submitted.

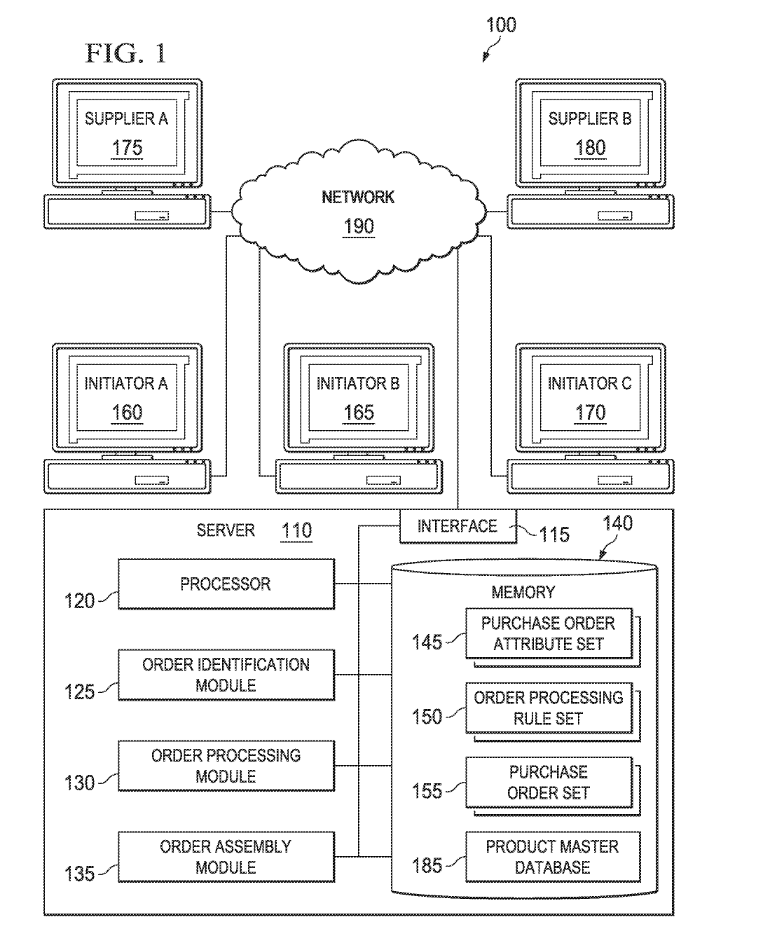

FIG. 1 is a schematic representation of an example system environment 100 suitable for one or more implementations according to the present disclosure. At a high level, the example system environment 100 includes, or is communicably coupled with, a server 110, purchase order initiators, 160, 165, 170, purchase order suppliers 175, 180, and a network 190. The server 110 can be responsible for handling purchase orders, including identifying purchase orders that can be combined to form a combined purchase order based on attributes of the purchase orders, postponing purchase orders based on one or more stop rules, and restarting purchase process after pulling together a combined purchase order based on one or more restarting rules.

In the example system environment 100 illustrated in FIG. 1, the server 110 can include a processor 120, an interface 115, an order identification module 125, an order processing module 130, an order assembly module 135, and a memory 140. At a high level, the server 110 can be any computing device or a procurement system that can handle purchase orders or perform a procurement process according to the various implementations of the present disclosure.

In general, a server includes an electronic computing device operable to receive, transmit, process, store, or manage data and information associated with the system environment 100. The server may be responsible for communicating with one or more purchase order initiators 160, 165, 170 and suppliers 175, 180 to perform the procurement process. Indeed, the server may be any computer or processing device such as, for example, a blade server, general-purpose personal computer (PC), Macintosh®, workstation, UNIX-based workstation, or any other suitable device. In other words, the present disclosure contemplates computers other than general purpose computers, as well as computers without conventional operating systems. Furthermore, the server may be adapted to execute any operating system, including Linux, UNIX, Windows®, Mac OS®, or another suitable operating system.

The server 110 includes a processor 120. Although illustrated as a single processor 120 in FIG. 1, two or more processors may be used according to particular needs, desires, or particular embodiments of system environment 100. Each processor 120 may be a central processing unit (CPU), a blade, an application specific integrated circuit (ASIC), a field-programmable gate array (FPGA), or another suitable component. Generally, the processor 120 executes instructions and manipulates data to perform the operations of the server 110 and, specifically, processing purchase orders. Specifically, the processor 120 executes functionalities required to receive and respond to requests from the purchase order initiators 160, 165, 170 and/or the suppliers 175, 180.

The functionalities of the server 110 may further be supported by the order identification module 125, order processing module 130, and order assembly module 135. The order identification module 125 can be a hardware/software module used for identifying one or more attributes associated with purchase orders received from one or more initiators 160, 165, 170. The one or more attributes may be attributes that can allow at least a portion of the purchase order to be combined with other purchase orders that share the same attributes. For example, the attributes that allow purchase orders to be combined can include attributes associated with material of a product and associated services included in the purchase order. The received purchase orders from one or more initiators 160, 165, 170 can be stored as purchase order set 155 included in the memory 140.

The material of product and associated services may be stored in a product master database 185 included in the memory 140. The product master database 185 can store information of products associated with the system environment 100. For each product type, information including product type category, material of product, requested services associated with product type, product specifications or any other relevant product characteristics, description, and functionalities. The one or more attributes of purchase orders that can be used to combine or aggregate purchase orders to form a combined order with larger purchase amounts or other combined attributes can be stored as a purchase order attribute set 145 included in a memory 140. The order identification module may parse the purchase order attribute set 145 to identify whether a purchase order received from the one or more initiators 160, 165, 170 include products that have attributes that match the attributes or criteria included in the purchase order attribute set 145.

The order processing module 130 may be a hardware and/or software module for processing the purchase order requests from the initiators 160, 165, 170 based on one or more fixed and/or dynamic rules. The order processing module 130 may parse order processing rules included in an order processing rule set 150 stored in the memory 140 to determine whether an order processing rule is triggered or satisfied. In some instances, order processing rules can be stop rules. In some other instances, order processing rules can be restart rules. Stop rules can be rules that when satisfied, postpone at least a portion of a purchase order from being submitted until one or more restart rules are satisfied. Restart rules can be rules that when satisfied, submit at least the portion of the postponed purchase order together with portions of one or more other purchase orders in a combined purchase order. Both stop rules and restart rules can be either fixed rules or dynamic rules. In some instances, one stop rule may be associated with multiple restart rules, providing several triggering events that may restart the procurement process.

A fixed rule may be an order processing rule that is stored in the order processing rule set 150 of the memory 140 that when triggered, automatically stops or restarts the procurement process, depending on whether the fixed rule is a stop rule or a restart rule. For example, a product may be categorized into a predetermined product level, which in turn, is an attribute of the product. A stop rule that is associated with the predetermined product level may be triggered, which results in postponing the purchase order of the product from being submitted for a certain amount of time (e.g., one week). After the one week criterion is met, the order processing module 130 may trigger the restart rule and submit the purchase order with other received purchase orders that have the same attribute.

A dynamic rule may be a more flexible order processing rule that is stored in the order processing rule set 150 and shared by the procurement system (i.e., the server 110) and at least one of the suppliers 175, 180. Furthermore, the procurement system can offer services including pricing procedure or automatic supply determination based on the dynamic rules. In some implementations, the dynamic rules may also be bounded to a stop rule. For example, a first purchase order may include a first product that is postponed to be submitted to at least one supplier based on a one week fixed waiting time stop rule. When a second purchase order that includes a second product that shares at least one attribute associated with the stop rule is received by the procurement system, a dynamic rule may apply to the second product. The dynamic rule may be a waiting time less than the one week fixed waiting time of the first product.

The order assembly module 135 may be a hardware and/or software module that responds to one or more restarting rules. The order assembly module 135 may be responsible for identifying products in different purchase orders that share one or more attributes, automatically combining these products to a combined purchase order, and submitting the combined purchase order to at least one of the suppliers 175, 180 in response to a restarting rule being triggered. The products that share one or more attributes included in the combined purchase order may sometimes be referred to as a product pool. Accordingly, the operation of assembling purchase orders performed by the server 110 or the order assembly module 135 may be referred to as “pooling”.

Returning to the description of the processor 120, regardless of the particular implementation, the processor 120 may be operable to execute one or more applications (or software) related to handling purchase orders. “Software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java™, Visual Basic, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated system environment 100, processor 120 executes one or more application codes 175 of the application server 110.

Processors 120 suitable for the execution of a computer program include, by way of example, both general and special purpose microprocessors, and any one or more processors of any kind of digital computer. Generally, a processor 120 will receive instructions and data from a read-only memory, a random access memory, or both. The essential elements of a computer are a processor 120 for performing actions in accordance with instructions and one or more memory devices for storing instructions and data. Generally, a computer will also include, or be operatively coupled to receive, data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto optical disks; CD-ROM and DVD-ROM disks. The processor 120 and the database (or memory) can be supplemented by, or incorporated in, special purpose logic circuitry.

The memory 140 included in the server 110 may be any memory module or database and may take the form of volatile or non-volatile memory including, without limitation, magnetic media, optical media, random access memory (RAM), read-only memory (ROM), removable media, or any other suitable local or remote memory component. In general, the memory 140 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the application server 110, the client 140, and/or the application codes 175. Additionally, the memory 140 may include any other appropriate data, such as virtual private network (VPN) applications, firmware logs and policies, firewall policies, a security or access log, print or other reporting files, as well as others.

As shown in FIG. 1, the server 110 also includes an interface 115. In general, the interface 115 is used for communicating with other systems in the illustrated example system environment 100 through the network 190. The interface 115 includes logic encoded in software and/or hardware in a suitable combination and operable to communicate with the network 190. More specifically, the interface 115 may comprise software supporting one or more communication protocols associated with communications such that the network 190 or interface's hardware is operable to communicate physical signals within and outside of the illustrated system environment 100. In some instances, the interface's hardware may include wireless transceivers and antennas (not shown). The wireless transceivers can include both the transmitter circuitry and the receiver circuitry. The wireless transceivers may be responsible for up-converting a baseband signal to a passband signal, or vice versa. The components of wireless transceivers may include a digital-to-analog converter/analog-to-digital converter, amplifier, frequency filter, and oscillator. The antenna is a transducer which can transmit and/or receive electromagnetic waves. The antenna can convert electromagnetic radiation into electric current, or vice versa. The antenna is generally responsible for the transmission and reception of radio waves, and can serve as the interface between the transceiver and the wireless channel.

As described previously, the order identification module 125, order processing module 130 and order assembly module 135 may be included in one or more software applications. At a high level, each of the one or more software applications can be any application, program, module, process, or other software that may execute, change, delete, generate, or otherwise manage information according to the present disclosure, particularly in response to and in connection with one or more requests received from the illustrated initiators 160, 165, 170 and/or the suppliers 175, 180. In certain cases, only one application may be located at the memory 140. In others, a plurality of related and/or unrelated applications may be stored at a single memory, or located across a plurality of other system components, as well. In certain cases, system environment 100 may implement a composite application. For example, portions of the composite application may be implemented as Enterprise Java Beans® (EJBs), or design-time components may have the ability to generate runtime implementations into different platforms, such as J2EE® (Java™ 2 Platform, Enterprise Edition), ABAP (Advanced Business Application Programming) objects, or Microsoft's®.NET, among others. Additionally, the applications may represent web-based applications accessed and executed by the client 140 and/or the application server 110 via the network 190 (e.g., through the Internet). Further, while illustrated as internal to memory 140, one or more processes associated with a particular application may be stored, referenced, or executed remotely. For example, a portion of a particular application may be a web service associated with the application that is remotely called, while another portion of the application may be an interface object or agent bundled for processing at the initiators 160, 165, 170 and/or the server 110. Moreover, any or all of the applications may be a child or sub-module of another software module or enterprise application (not illustrated) without departing from the scope of this disclosure. Still further, portions of the application may be executed by a user working directly at the memory 140, as well as remotely at client 140 and the application server 110.

Although a single server 110 is illustrated for the procurement process, in general, any number of computing devices that are associated with logic for handling purchase orders may be used or incorporated into the described execution.

Purchase order initiator A 160, purchase order initiator B 165 and purchase order initiator C 170 may be any person or purchasing entity that initiates purchase orders via a client device. The combined purchase order may include purchase orders received from a single client device or multiple client devices. The client device can be any computing device that can execute purchase order initiation, such as a desktop computer, a laptop computer, a smartphone, and tablet computer. The client devices can include user interfaces (not shown). The user interfaces can be used to perform interactions between a client and other components of the system environment 100, including the server 110 and the suppliers 175, 180. For example, the user interface can be used as the interface for browsing merchandise, purchasing, and shopping cart contents provided through business applications, and making purchase order requests to the server 110 and/or the suppliers 175, 180. In some implementations, instead of receiving purchase order requests from the purchase order initiators 160, 165, 170, one or more purchase orders may also be generated locally at the server 110.

The supplier A 175 and supplier B 180 may be responsible for fulfilling purchase orders submitted by the server 110 and/or the initiators 160, 165, 170. Example suppliers may include product manufacturers, product distributors, wholesalers, dealerships, or merchants, as well as other suitable suppliers. Although three initiators 160, 165, 170 and two suppliers 175, 180 are shown in the illustrated system environment 100, it will be understood that any number of initiators and suppliers can operate in the example system environment 100.

The server 110, initiators 160, 165, 170, and suppliers 175, 180 are communicably coupled via a network 190. The network 190 may be all or a portion of an enterprise or secured network, while in another instance, at least a portion of the network 190 may represent a connection to the Internet. In some instances, a portion of the network 190 may be a virtual private network (VPN). Further, all or a portion of the network 190 can comprise either a wireline or wireless link. Example wireless links may include 802.11a/b/g/n, 802.20, WiMAX®, Bluetooth® and/or any other appropriate wireless link. In other words, the network 190 encompasses any internal or external network, networks, sub-network, or combination thereof operable to facilitate communications between various computing components inside and outside the illustrated environment. The network 190 may communicate, for example, Internet Protocol (IP) packets, Frame Relay frames, Asynchronous Transfer Mode (ATM) cells, voice, video, data, and other suitable information between network addresses. The network 190 may also include one or more local area networks (LANs), radio access networks (RANs), metropolitan area networks (MANs), wide area networks (WANs), all or a portion of the Internet, and/or any other communication system or systems at one or more locations.

While FIG. 1 is described as containing or being associated with a plurality of elements, not all elements illustrated within system environment 100 of FIG. 1 may be utilized in each alternative implementation of the present disclosure. Additionally, one or more of the elements described herein may be located external to system environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

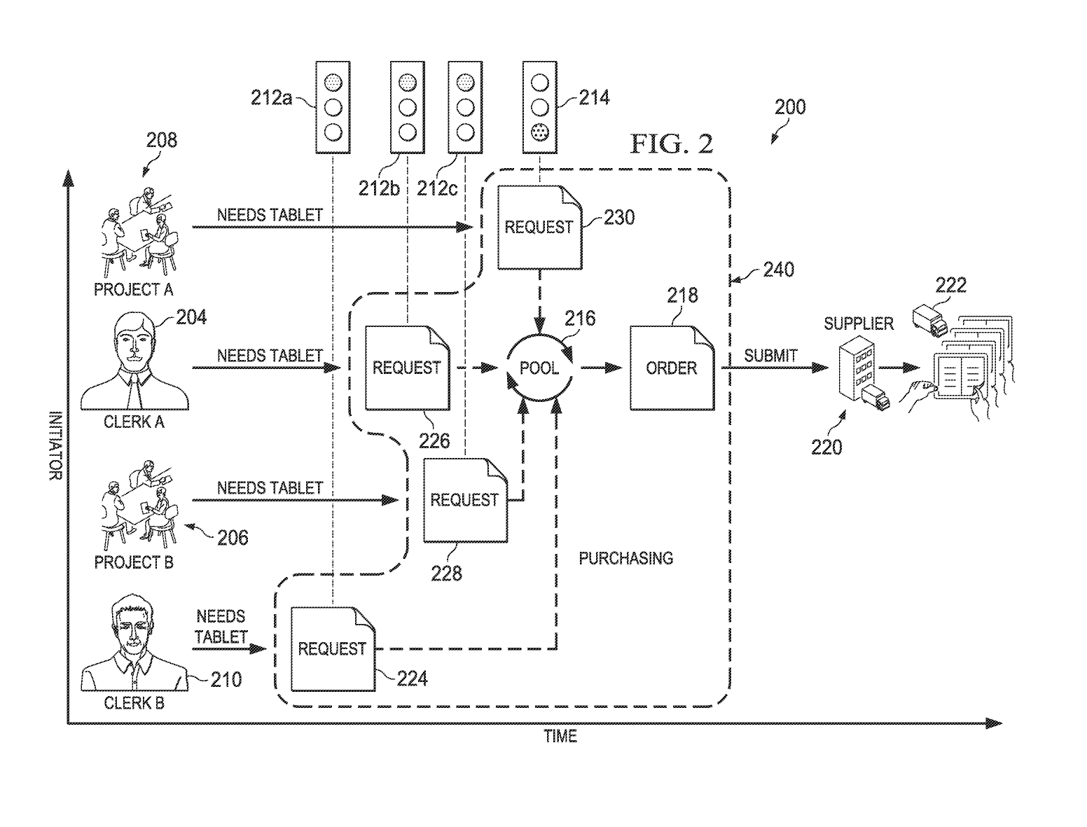

FIG. 2 is a schematic showing an example system 200 for handling purchase orders. The example system 200 includes high level components comprising purchase order initiators 204, 206, 208, 210, a procurement system 240, a supplier 220 and an order shipment agent 222. The initiator may be a person or a party that can operate one or more client devices, such as the client devices described with regard to FIG. 1, to make purchase order requests to the order pooling system 216. In the illustrated example system 200, the initiators include project A 208 and project B 206, which may initiate purchase orders of, for example, equipment for their respective projects. The initiators also include clerk A 204 and clerk B 210, who may initiate purchase orders of, for example, office supplies for office uses.

In an example procurement process, clerk B 210 can initiate a first purchase order request 224. The first order request may be a purchase order for a tablet computer. Generally, the first purchase order request 224 can include one or more products associated with attributes that allow said products to be combined with other purchase orders. Example attributes that allow at least a portion of purchase orders to be combined can include an attribute of a service requested by the purchase order initiators, an attribute of a category level of the product, an origin of the purchase order, an assigned vendor of the purchase order, the recipient of the product fulfilled by the assigned vendor, or an indication of a purchase order priority level provided by a purchase order initiator. For example, when a purchase order includes a software product that belongs to a software upgrade category, this software product may be combined with other software products in order to form a larger procurement amount, where the larger procurement amount provides bulk or shipping discounts. As another example, when a purchase order is requested to be fulfilled by a certain vendor, the purchase order may be combined with other purchase orders to obtain a discount from the vendor known by the pooling system 216.

When one or more stop rules are identified to be associated with one or more attributes of the purchase order request 224, the purchase order request 224 can be postponed 212a by the procurement system 240 to be submitted to the supplier 220. The procurement system may include a server such as the server 110 described with regard to FIG. 1. The stop rules may be at least a subset of a fixed rule set and/or dynamic rule set associated with the product attributes.

The fixed rule set can comprise fixed rules including maximum waiting time for submitting the first purchase order based on one or more purchase order priority levels. The one or more purchase order priority levels can include a priority level of a purchase order initiator, purchase order initiator's company, product category associated with the first purchase order, or a product associated with the first purchase order. For example, the priority level of a purchase order initiator who is a project team can be higher than the priority level of a purchase order initiator who is a clerk. Thus, the maximum waiting time of purchase orders for the project team may be shorter than for the clerk. As for another example, the priority level of office supplies can be higher than computer accessories. Thus, the maximum waiting time of purchase orders for office supplies may be shorter than for the computer accessories.

Example fixed rules can also include a fixed quantity of products associated with the combined purchase order, a fixed value of products associated with the combined purchase order, or a fixed number of purchase orders to be combined and submitted. For example, a quantity of four tablet computers may qualify for a 10% discount from a tablet computer supplier, a purchase order that includes a tablet computer may be postponed and restarted to be submitted to the supplier when four tablet computer orders are accumulated.

The dynamic rule set can comprise rules that are shared and dynamically adjustable by the procurement system 218 and/or the supplier 220. Example dynamic rules can include a cheapest price available for a product associated with the first purchase order request 224, a discount percentage according to a quantity of product associated with the combined order, or a cost of shipping, handling or insurance of the combined order.

The procurement system 240 may submit the first order request 224 to the supplier when at least one restart rule is satisfied. In the illustrated example 200, the restart rule that triggers submission of a combined order 218 is to accumulate four tablet computers, such that a bulk discount can be realized from the seller. Generally, the restart rules may be at least a subset of a fixed rule set or dynamic rule set associated with the product attributes. The fixed rule set can comprise fixed rules substantially similar to the fixed rules described previously with regard to the stop rules. The dynamic rule set can comprise dynamic rules substantially similar to the dynamic rules described previously with regard to the stop rules.

The stop rule associated with postponing the first purchase order and the restart rule associated with submitting the combined order may be the same or different. For example, the first purchase order 224 may be postponed from being submitted based on identifying that the tablet computer is associated with a fixed quantity stop rule, i.e., a combined order of four tablet computers qualifies for a discounted price from the supplier 220. When four tablet computers order requests are accumulated by the procurement system 240, the combined purchase order 218 is submitted. In such case, the effective stop rule and the effective start rule are the same. As for another example, the first purchase order 224 may be postponed from being submitted based on identifying that the tablet computer is associated with a maximum waiting time stop rule. For example, a tablet computer purchase order can wait for one month to be fulfilled. However, before the one month waiting period expires, four tablet computer orders are accumulated to qualify a discounted price from the supplier 220. A restart rule of having four tablet computers can be triggered, and a combined order of the four tablet computers may be submitted by the procurement system 240. In such case, the effective stop rule and the effective start rule are different.

Returning to the description of FIG. 2, clerk A 204 can also send a purchase order request 226 for a tablet computer. Since the purchase order request 226 includes a product (i.e., the tablet computer) that has the same, or common, attributes with the first purchase order request 224, the second order 226 request is postponed 212b from being submitted by the procurement system 240. The procurement system 240 may use an order pooling module 216 to combine the first purchase request 224 with the second purchase request 226. The order pooling module 216 may be a module assembly module 135 described with regard to FIG. 1. Similarly, a project group B 206 can submit a purchase order request 228 for a tablet computer, and a project group A 208 can submit a purchase order request 230 for a tablet computer. The submitted purchase order requests are combined by the order pooling module 216. Since four tablet orders are included in the combined order 218, the restart rule is satisfied 214, and the combined order 218 is sent to the supplier 220. After the supplier 220 processed the combined order, the shipping agent 222 can ship the four tablet computer to the initiators. When the four purchase order initiators are associated with an organization at the same physical location, the shipping agent 222 can deliver the four tablet computer in a single shipment to save on shipping costs.

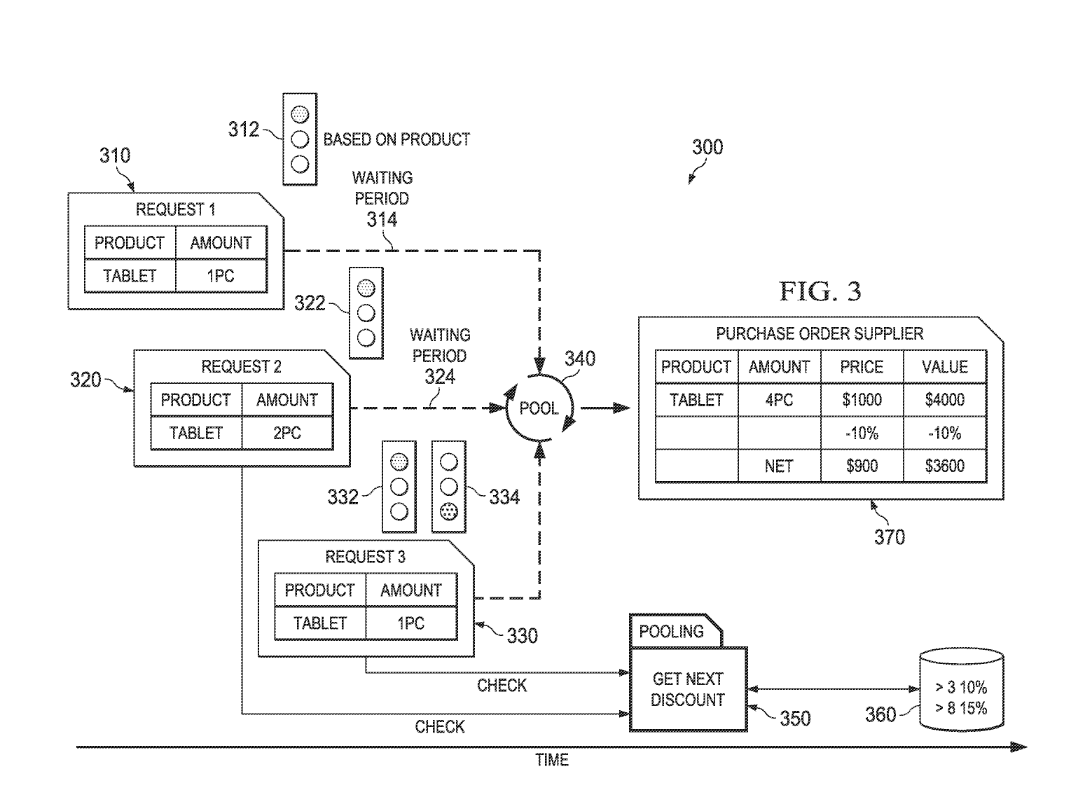

FIG. 3 is a schematic showing an example process 300 of handling purchase orders. In the illustrated example process 300, a first purchase order request 310 includes one tablet computer. Based on the attributes of the product in the first purchase order request 310, one or more stop rules may be identified. The first purchase order request may be postponed 312 based on the one or more stop rules. As described with regard to FIG. 2, example stop rules can include a maximum waiting period 314 for tablet computers, or a fixed quantity of four tablet computers. In the illustrated example process 300, the restart rule may be a dynamic rule 360, i.e., for more than three tablet computers, a 10% discount of the total value can be offered by a purchase order supplier, and for more than eight tablet computers, a 15% discount of the total value can be offered.

After receiving the first purchase order request, a second purchase order request 320 for two tablet computers. The waiting period 324 associated with the second purchase order is shorter than the waiting period 314 associated with the first purchase order. The second purchase order request 320 is combined with the first purchase order request 310 by the order pooling module 340. However, the second purchase order request 310 is postponed 322 from being submitted, since the restart rule is not satisfied. A third purchase order request 330 for a tablet computer is received by the order pooling module 340 after receiving the first purchase order 310 and the second purchase order 320. Since four tablet computers have being accumulated by the order pooling module 300, the dynamic restart rule is triggered. The order pooling module can decide whether to postpone 332 the combined purchase order to get the next discount 350, or submit 334 the combined purchase order to a supplier. In some instances, when a maximum waiting time 314 restart rule applies to the first purchase order request 310, the order pooling module submit 334 the combined order when no more than eight tablet computers are received before the maximum waiting time 314 expires. In such case, a 10% discount is applied to the combined purchase order at the purchase order supplier 370. In some other instances, when purchase orders that include more than eight tablet computers are received before the maximum waiting time expires, the order pooling module 340 can submit the combined order after a better discount (i.e., 15%) is available.

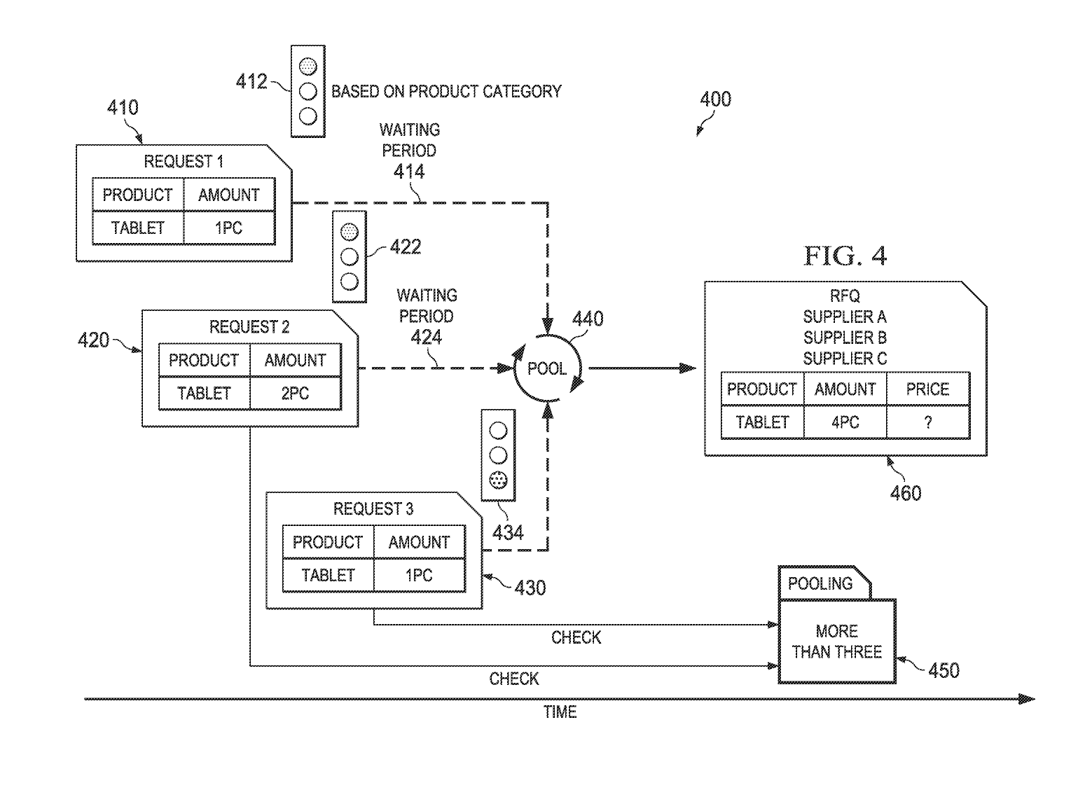

FIG. 4 is a schematic showing another example process 400 of handling purchase orders. In the illustrated example process 400, a first purchase order request 410 includes a tablet computer. Based on the attributes of the product in the first purchase order request 410, one or more stop rules may be identified. The first purchase order request may be postponed 412 based on the one or more stop rules. As described with regard to FIG. 2, example stop rules can include a maximum waiting period 414 for tablet computers, or a fixed quantity of four tablet computers. In the illustrated example process 400, the restart rule may be a dynamic rule 460, i.e., when a combined order of more than three tablet computers is pooled together by an order pooling module 440, discount offers may be available from more than one supplier 460. Accordingly, a request for quotation (RFQ) can be submitted to the more than one supplier 460 for the best discount offer available.

After receiving the first purchase order request 410, the order pooling module 440 receives a second purchase order request 420. The waiting period 424 associated with the second purchase order is shorter than the waiting period 414 associated with the first purchase order. The second purchase order request 420 is combined with the first purchase order request 410 by the order pooling module 440. However, the second purchase order request 410 is postponed 422 from being submitted, since the restart rule is not satisfied. A third purchase order request 430 for a tablet computer is received by the order pooling module 440 after receiving the first purchase order 410 and the second purchase order 420. Since more than three tablet computers have being pooled 450 by the order pooling module 400, the restart rule is triggered. The order pooling module 440 can submit 434 the request for quotation (RFQ) can to the more than one supplier 460 for the best discount offer available.

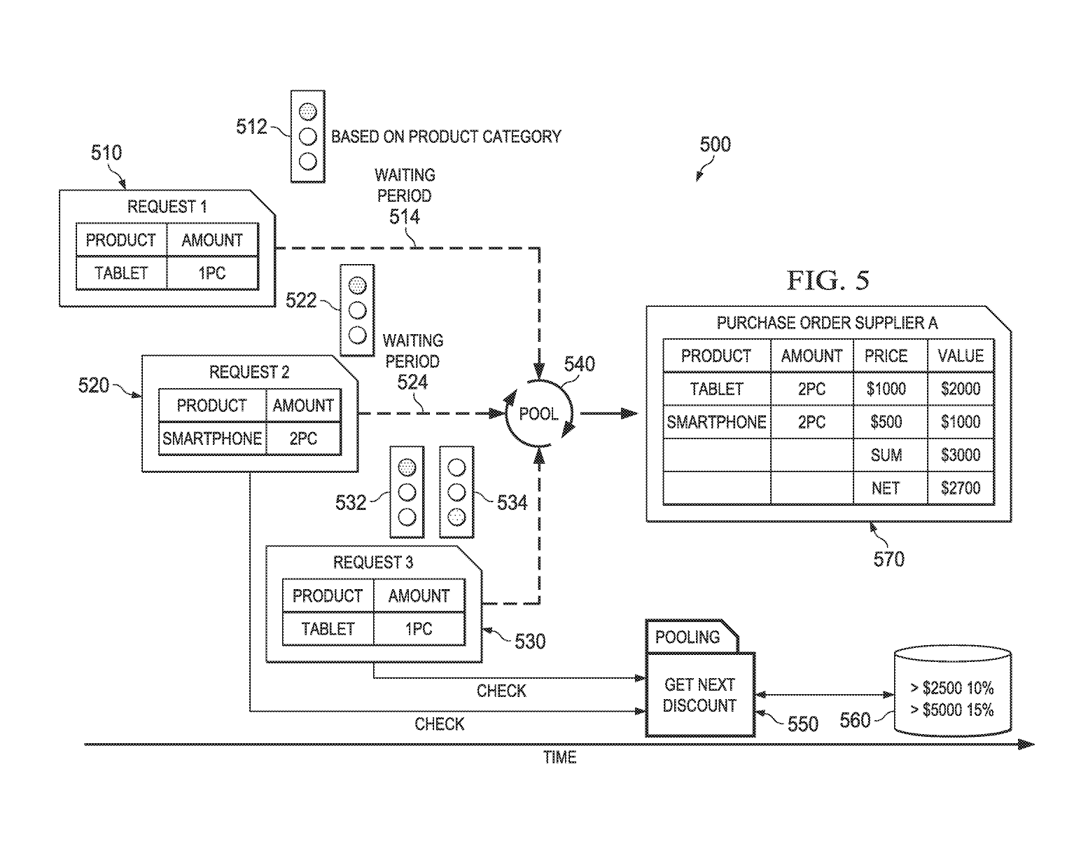

FIG. 5 is a schematic showing yet another example process 500 of handling purchase orders. In the illustrated example process 500, a first purchase order request 510 includes a tablet computer. Based on the attributes of the product in the first purchase order request 510, one or more stop rules may be identified. The first purchase order request may be postponed 512 based on the one or more stop rules. As described with regard to FIG. 2, example stop rules can include a maximum waiting period 514 for tablet computers, or a fixed quantity of four tablet computers. In the illustrated example process 500, the restart rule may be a dynamic rule 560, i.e., for purchase orders that worth more than $2500 of electronic devices, a 10% discount of the total value can be offered by a purchase order supplier, and for purchase orders that worth more than $5000 of electronic devices, a 15% discount of the total value can be offered.

After receiving the first purchase order request, the order pooling module 540 receives a second purchase order request 520 for two smart phones. The waiting period 524 associated with the second purchase order is shorter than the waiting period 514 associated with the first purchase order. The second purchase order request 520 is combined with the first purchase order request 510 by the order pooling module 540, since both purchase orders include the same product attributes (i.e., electronic devices). However, the second purchase order request 520 is postponed 522 from being submitted, since the restart rule is not satisfied. A third purchase order request 530 for a tablet computer is received by the order pooling module 540 after receiving the first purchase order 510 and the second purchase order 520. Let the value of a tablet computer be $1000 and the value of a smart phone be $500, since the accumulated value of the four electronic devices is greater than $3000, which is greater than the $2500 first threshold of the restart rule, the dynamic restart rule is then triggered. The order pooling module can decide whether to postpone 532 the combined purchase order to get the next discount 550, or submit 534 the combined purchase order to a supplier. In some instances, when a maximum waiting time 514 restart rule applies to the first purchase order request 510, the order pooling module submits 534 the combined order when no more than $5000 worth of product order is received before the maximum waiting time 514 expires. In such case, a 10% discount is applied to the combined purchase order at the purchase order supplier 570. In some other instances, the order pooling module submits 534 the combined order when more than $5000 worth of purchase orders for electronic devices is received before the maximum waiting time 514 expires, in order to get a better (i.e. 15%) discount.

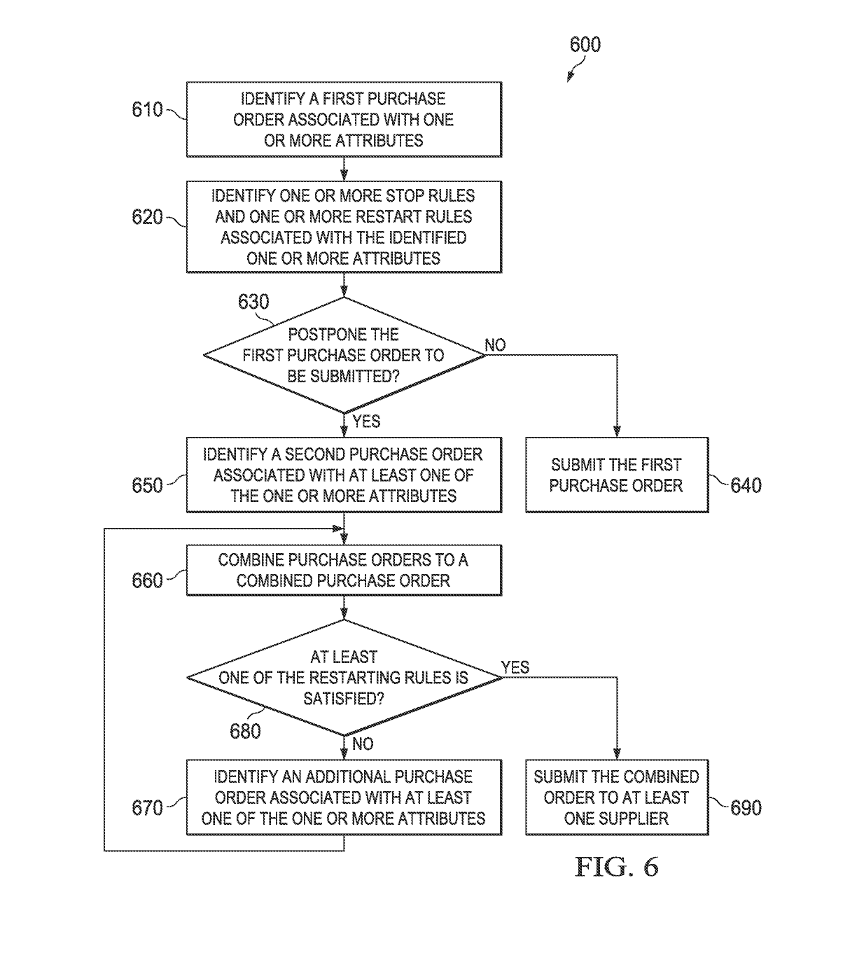

FIG. 6 is a flowchart showing an example process 600 of handling purchase orders. The example process 600 may be performed by a procurement system, such as the server 110 described with regard to FIG. 1. At 610, the procurement system identifies a first purchase order associated with one or more attributes. The one or more attributes may include attributes described with regard to FIG. 1 and FIG. 2. The one or more attributes may be associated with one or more stop rules that can allow at least a portion of the first purchase order to be postponed and combined with at least a portion of a second purchase order. As such, a larger order may be accumulated in order to obtain benefits from wholesale.

At 620, the procurement system identifies one or more stop rules and one or more restart rules associated with the identified one or more attributes of the first purchase order. The one or more stop rules and the one or more restart rules may be the stop rules and restart rules described respectively with regard to FIG. 1 and FIG. 2.

At 630, the procurement system determines whether to postpone the submission of the at least the portion of the first purchase order. The determination may be based on whether at least one of the one or more attributes is associated with at least one of the stop rules. For example, a purchase order of a tablet computer may be associated with a product attribute of “tablet” and a product category attribute of “electronic device.” When the stop rules include such attributes, e.g., 15% discount when purchasing more than eight “tablets” or 10% discount for $2000 worth of “electronic devices,” the procurement system may determine to postpone the submission of the purchase order. Otherwise, the example process 600 proceeds to 640, where the procurement system submit the first purchase order.

At 650, the procurement system identifies a second purchase order associated with at least one of the one or more attributes. For example, if a second purchase order includes a tablet, it then shares the product attribute “tablet,” and the product category attribute “electronic device” with the first purchase order. If the second purchase order includes a smart phone, it then shares the product category attribute “electronic device” with the first purchase order. In some implementations, the procurement system can automatically combine purchase orders when at least one attribute is identified to be associated with said purchase orders. In some other implementations, the procurement system can combine purchase orders based on user preferences or a dynamic determination rule. For example, if a purchase order needs to be fulfilled as soon as possible from a high priority purchase order initiator, the procurement system may not wait for a restart rule to be met to submit said purchase order. In some implementations, in addition to or instead of combining purchase orders based on one or more common attributes, the procurement system may also determine the time and suitability of combining purchase orders based on other criteria.

At 660, the procurement system combines the purchase orders into a combined purchase order. In some implementations, only a portion of the first purchase order and/or a portion of the second purchase order include one or more products associated with the one or more attributes. In such cases, only the portions of the first purchase order and the second purchase order are combined. In those instances, the portions not associated with a particular stop/restart rule may be submitted to the procurement system without postponement, while the relevant portions of the first and second purchase orders are combined and postponed.

At 680, the procurement system determines if at least one of the restart rules is satisfied. If a restart rule is satisfied, the example process 600 proceeds to 690, where the procurement system submits the combined purchase order to at least one supplier. Otherwise, the example process 600 proceeds to 670. In some implementations, the procurement system may evaluate more than one restart rule. The example process proceeds to 690 when the procurement system determines a first of the more than one restart rule is satisfied. At 670, the procurement system identifies an additional purchase order associated with at least one of the one or more attributes. In some implementations, the procurement system may also identify other criterion to determine the time and suitability for combining the additional purchase order. Afterwards, the example process 600 circulates back to 600, where the procurement system combines the identified purchase orders to a combined purchase order.

While this specification contains many specific implementation details, these should not be construed as limitations on the scope of any that may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described components and systems can generally be integrated together in a single product or packaged into multiple products.

In the present disclosure, “each” refers to each of multiple items or operations in a group, and may include a subset of the items or operations in the group and/or all of the items or operations in the group. In the present disclosure, the term “based on” indicates that an item or operation is based at least in part on one or more other items or operations and may be based exclusively, partially, primarily, secondarily, directly, or indirectly on the one or more other items or operations.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A method comprising:
identifying a first purchase order, wherein at least a portion of the first purchase order associated with one or more attributes;
identifying one or more stop rules and one or more restart rules associated with at least one of the identified one or more attributes;
postponing the at least the portion of the first purchase order to be submitted to at least one supplier based on the identified one or more stop rules;
identifying a second purchase order, wherein at least a portion of the second purchase order is associated with at least one of the one or more attributes while the first purchase order is postponed;
combining at least the portion of the first purchase order and at least the portion of the second purchase order to a combined purchase order; and
submitting the combined purchase order to at least one supplier when at least one of the one or more restart rules is satisfied.

2. The method of claim 1, further comprising submitting the first purchase order when none of the one or more stop rules is satisfied.

3. The method of claim 1, further comprising:
identifying a third purchase order that includes at least one of the one or more attributes when none of the one or more restarting rules is satisfied; and
combining the third purchase order to the combined purchase order.

4. The method of claim 1, further comprising:
identifying a third purchase order that includes at least one of the one or more attributes when none of the one or more restarting rules is satisfied;
determining the third purchase order should not be included in the combined purchase order; and
submitting the third purchase order to at least one supplier.

5. The method of claim 1, wherein the one or more attributes include at least one of an attribute of a product associated with a purchase order, an attribute of a service requested by the purchase order, an attribute of a category level of the product, an origin of the purchase order, an assigned vendor of the purchase order, the recipient of the product fulfilled by the assigned vendor, or an indication of a purchase order priority level provided by a purchase order initiator.

6. The method of claim 1, wherein the one or more stop rules and the one or more restarting rules include at least one of a set of fixed rules or a set of dynamic rules.

7. The method of claim 6, wherein the set of fixed rules include a maximum waiting time for submitting the first purchase order based on one or more purchase order priority levels, a fixed quantity of products associated with the combined purchase order, a fixed value of products associated with the combined purchase order, or a fixed number of purchase orders to be combined and submitted.

8. The method of claim 7, wherein the one or more purchase order priority levels include at least one of a priority level of a purchase order initiator, purchase order initiator's company, product category associated with the first purchase order, or a product associated with the first purchase order.

9. The method of claim 6, wherein the set of dynamic rules is a set of rules that is adjustable based on at least one of a cheapest price available for a product associated with the first purchase order, a discount percentage according to a quantity of product associated with the combined order, or a cost of shipping, handling or insurance of the combined order.

10. The method of claim 1, further comprising providing services including at least one of a pricing procedure or automatic supply determination when the one or more order processing rules include a set of dynamic rules.

11. A computer program product comprising computer-readable instructions embodied on tangible, non-transient media, the computer program product operable when executed to perform operations including:
identifying a first purchase order, wherein at least a portion of the first purchase order associated with one or more attributes;
identifying one or more stop rules and one or more restart rules associated with at least one of the identified one or more attributes;
postponing the at least the portion of the first purchase order to be submitted to at least one supplier based on the identified one or more stop rules;
identifying a second purchase order, wherein at least a portion of the second purchase order is associated with at least one of the one or more attributes while the first purchase order is postponed;
combining at least the portion of the first purchase order and at least the portion of the second purchase order to a combined purchase order; and
submitting the combined purchase order to at least one supplier when at least one of the one or more restart rules is satisfied.

12. The computer program product of claim 11, further operable when executed to perform operations including submitting the first purchase order when none of the one or more stop rules is satisfied.

13. The computer program product of claim 11, further operable when executed to perform operations including:
identifying a third purchase order that includes at least one of the one or more attributes when none of the one or more restarting rules is satisfied; and
combining the third purchase order to the combined purchase order.

14. The computer program product of claim 11, further operable when executed to perform operations including:
identifying a third purchase order that includes at least one of the one or more attributes when none of the one or more restarting rules is satisfied;
determining the third purchase order should not be included in the combined purchase order; and
submitting the third purchase order to at least one supplier.

15. The computer program product of claim 11, wherein the one or more attributes include at least one of an attribute of a product associated with a purchase order, an attribute of a service requested by the purchase order, an attribute of a category level of the product, an origin of the purchase order, an assigned vendor of the purchase order, the recipient of the product fulfilled by the assigned vendor, or an indication of a purchase order priority level provided by a purchase order initiator.

16. The computer program product of claim 11, wherein the one or more stop rules and the one or more restarting rules include at least one of a set of fixed rules or a set of dynamic rules.

17. The computer program product of claim 16, wherein the set of fixed rules include a maximum waiting time for submitting the first purchase order based on one or more purchase order priority levels, a fixed quantity of products associated with the combined purchase order, a fixed value of products associated with the combined purchase order, or a fixed number of purchase orders to be combined and submitted.

18. The computer program product of claim 17, wherein the one or more purchase order priority levels include at least one of a priority level of a purchase order initiator, purchase order initiator's company, product category associated with the first purchase order, or a product associated with the first purchase order.

19. The computer program product of claim 16, wherein the set of dynamic rules is a set of rules that is adjustable based on at least one of a cheapest price available for a product associated with the first purchase order, a discount percentage according to a quantity of product associated with the combined order, or a cost of shipping, handling or insurance of the combined order.

20. The computer program product of claim 1, further comprising providing services including at least one of a pricing procedure or automatic supply determination when the one or more order processing rules include a set of dynamic rules.

21. A system comprising:
a processor, operable to cause the run-time container to:
identify a first purchase order, wherein at least a portion of the first purchase order associated with one or more attributes;
identify one or more stop rules and one or more restart rules associated with at least one of the identified one or more attributes;
postpone the at least the portion of the first purchase order to be submitted to at least one supplier based on the identified one or more stop rules;
identify a second purchase order, wherein at least a portion of the second purchase order is associated with at least one of the one or more attributes while the first purchase order is postponed;
combine at least the portion of the first purchase order and at least the portion of the second purchase order to a combined purchase order; and
submit the combined purchase order to at least one supplier when at least one of the one or more restart rules is satisfied.
